(19) United States
(12) Patent Application Publication
(10) Pub. No.: US 2025/0327497 A1
(43) Pub. Date: Oct. 23, 2025

(54) SYSTEMS AND METHODS FOR BRAKE-EMISSIONS TESTING

(71) Applicant: HORIBA Instruments Incorporated, Irvine, CA (US)

(72) Inventors: Gregory Filer, Utterson (CA); Norman Malcolm Newberger, White Lake, MI (US)

(21) Appl. No.: 18/643,556

(22) Filed: Apr. 23, 2024

(51) Int. Cl. F16D 65/00; F16D 65/853; F16D 66/00

(52) U.S. Cl. CPC F16D 65/0031; F16D 65/853; F16D 66/00; F16D 2066/006

(57) ABSTRACT

A free-wheeling hub wheel can be mounted to a wheel hub of a vehicle such that the free-wheeling hub wheel surrounds a brake of the vehicle. A cover is disposed over the brake and mounted around a perimeter of a rim of the free-wheeling hub wheel such that the rim and cover define a sealed container completely encapsulating the brake to capture emissions from the brake.

### TECHNICAL FIELD

This disclosure relates to the testing of vehicles.

### BACKGROUND

Brake pads are a component of a vehicle's braking system, and they function primarily by creating friction against the brake rotor (disc) or drum to slow or stop the vehicle. This process may produce emissions primarily in the form of particulate matter.

Brake pads are typically made from a composite material which may include a mixture of binder, that holds the pad material together, fillers, that enhance certain properties like noise damping and friction, friction modifiers, that adjust the friction levels, fibers, that strengthen the pad, and abrasives, that clean the rotor surface. Common materials used include metals, like copper and steel, ceramic compounds, rubber, and several types of fibers, like carbon.

When a vehicle's brake pedal is pressed, hydraulic pressure forces the brake pads against the rotors/drums. The contact between the pad material and the rotating rotor generates friction. This friction converts kinetic energy into thermal energy, resulting in elevated temperatures at the contact surfaces.

The elevated temperatures and mechanical stresses cause the brake pad material to wear down over time. This wear can be a source of brake dust emissions. The particles released can be fine, in the range of a few nanometers to a few micrometers, and may be composed of metals, carbon compounds, and other materials found in the brake pads. The emitted particles are expelled into the air around the wheel and can become airborne due to their size and the turbulent air flow created by the moving vehicle.

The type of materials used in brake pads affects the amount and type of particulate emissions. For example, ceramic-based pads typically produce fewer and distinct types of particles compared to metallic pads. Frequent stopping, aggressive braking, and high-speed driving can increase brake wear and thus emissions. Higher temperatures can increase the rate of pad wear and particle emission. Additionally, humidity can affect the cohesiveness of the brake dust particles. Worn pads or those that are nearing the end of their service life can produce more emissions due to thinner material and potentially uneven wear surfaces.

Brake emissions testing is a field focused on measuring the particulate emissions from brake wear during driving conditions (actual or simulated).

### SUMMARY

A driving brake emissions measurement system has a free-wheeling hub wheel and tire assembly, including a stationary rim and tire each defining inlet and outlet ports, operatively arranged with a dynamometer and mounted to a wheel hub of a vehicle such that braking and motoring torques of the vehicle are transferred to the dynamometer via the free-wheeling hub wheel and tire assembly and the free-wheeling hub wheel and tire assembly surrounds a brake of the vehicle. The real-driving brake emissions measurement system also has a cover disposed over the brake and mounted to the free-wheeling hub wheel and tire assembly such that the rim and cover define a sealed container completely encapsulating the brake to capture emissions from the brake, and conduit passing through the tire via the inlet and outlet ports and configured to direct fluid through the sealed container to carry the emissions out of the sealed container and to an analyzer.

A free-wheeling hub wheel system has a free-wheeling hub wheel that can be mounted to a wheel hub of a vehicle such that the free-wheeling hub wheel surrounds a brake of the vehicle, and includes a rim defining inlet and outlet ports, and a cover that can be disposed over the brake and mounted around a perimeter of the rim such that the rim and cover define a sealed container completely encapsulating the brake to capture emissions from the brake.

A brake emissions testing method includes directing fluid in to and out of a sealed cavity defined by a stationary rim and cover of a free-wheeling hub wheel and tire assembly via conduit passing through a stationary tire of the free-wheeling hub wheel and tire assembly that is mounted on the rim to collect emissions from a brake contained within the sealed cavity.

### BRIEF DESCRIPTION OF THE DRAWINGS

FIG. 1A is a partial exploded view, in perspective, of a free-wheeling hub wheel system (vehicle inboard side).

FIG. 1B is a partial assembly view, in perspective, of the free-wheeling hub wheel system (vehicle inboard side).

FIG. 1C is an assembly view, in perspective, of the free-wheeling hub wheel system (vehicle outboard side).

FIGS. 2 and 3 are block diagrams of real-driving brake emissions measurement systems that use free-wheeling hub wheel systems similar to that of FIGS. 1A, 1B, and 1C.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Some brake emissions testing aims to quantify the emissions from braking systems to assess compliance with regulatory requirements for vehicle emissions. The tests may focus on measuring particulate matter and other emissions generated during use. An example would be to take total non-exhaust emissions as disclosed in U.S. Pat. No. 11,543,331 and subtract brake dust emissions to derive tire particulate emissions. Another example may be found in Pub. No. 2020/0150016.

A dynamometer (e.g., chassis dynamometer, inertia dynamometer, wheel dynamometer, etc.) is often used to simulate real-world driving conditions. It allows for the recreation of various driving scenarios while collecting data on brake emissions. Sensors and equipment are set up in an attempt to capture particulate matter and other emissions.

Before testing begins, a vehicle's braking system may be checked for wear, alignment, and proper operation. In some cases, the brakes are “bed-in” to ensure they are functioning consistently during testing.

Several test scenarios may be used. For city driving, stop-and-go traffic with frequent braking and acceleration is simulated to assess emissions during typical urban driving. For highway driving, higher-speed driving with less frequent but harder braking is simulated to assess emissions during longer, sustained drives. Aggressive braking may be used to evaluate emissions under heavy use, and extended braking may be used to evaluate emissions during prolonged periods, such as during long downhill descents.

Sensors capture and quantify released particulate matter. This is typically measured in milligrams per brake application or similar units. In some cases, additional sensors may measure gaseous emissions produced during braking. Moreover, brake temperatures may be monitored to reveal how heat affects emissions. Capturing vehicle speeds, pedal positions, brake temperatures, and ambient conditions allows for the simulation of real driving events in the controlled environment of the dynamometer test laboratory.

Tests may be repeated with different brake pad materials to compare emissions. Tests can also be conducted under varying temperature, humidity, and weather conditions to assess how these factors impact performance.

After collecting data, it is often analyzed to identify patterns, quantify emissions, and assess compliance with regulatory standards.

It can be difficult to capture emissions generated during brake testing. Here, systems and strategies are proposed for this purpose.

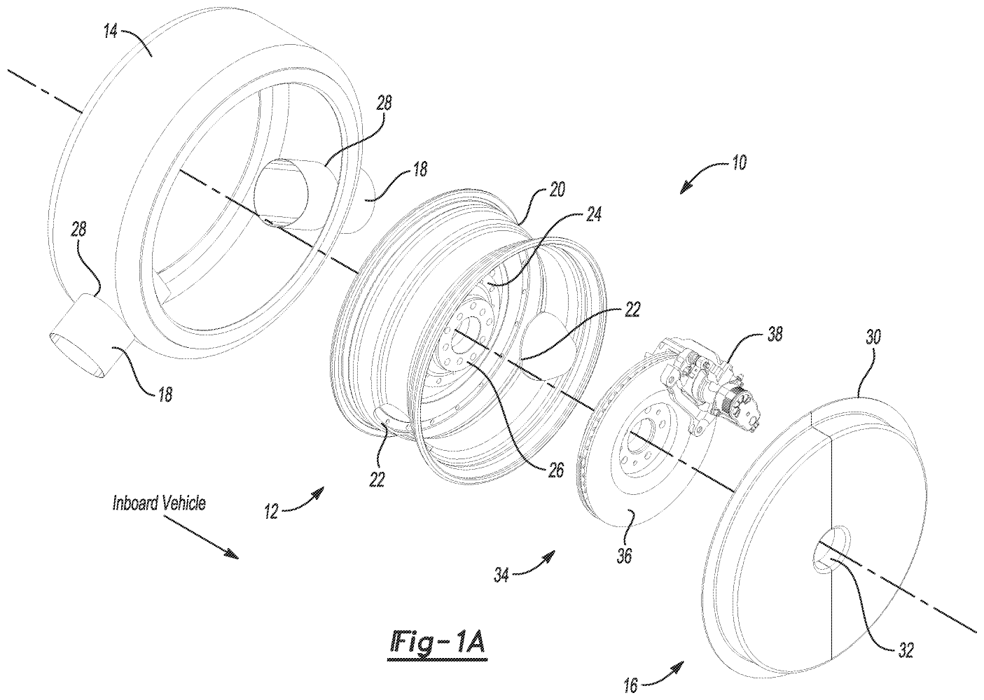

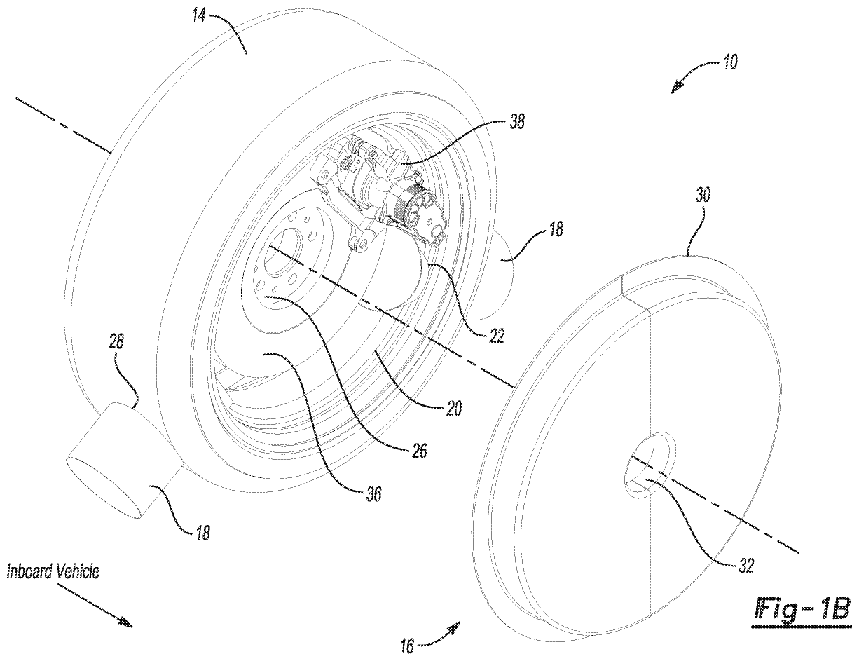

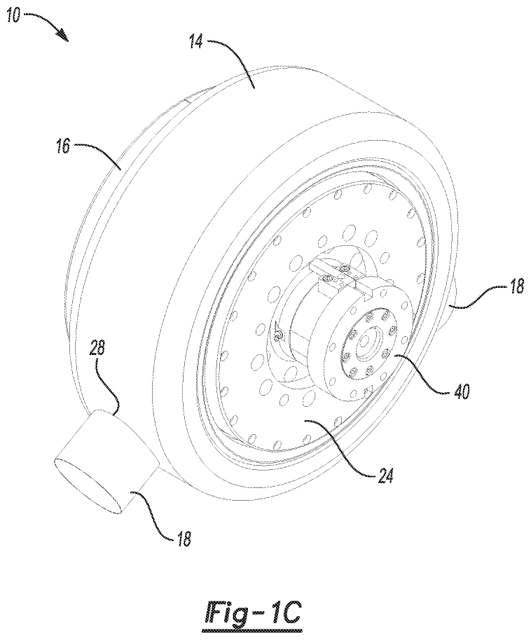

Referring to FIGS. 1A, 1B, and 1C, a free-wheeling hub wheel system 10 includes a free-wheeling hub wheel 12, a tire 14, a cover 16, and conduit 18. The free-wheeling hub wheel 12 includes a rim 20 defining inlet and outlet ports 22 configured to permit the conduit 18 to pass therethrough and to accommodate the tire 14 being mounted thereon, a disk plate assembly 24 having a perimeter joined to the rim 20, and a floating hub assembly 26 carried by a center of the disk plate assembly 24 via a bearing assembly of the floating hub assembly 26. The bearing assembly permits the floating hub assembly 26 to rotate relative to the rim 20 and disk plate assembly 24.

The tire 14 also defines inlet and outlet ports 28 configured to permit the conduit 18 to pass therethrough. When mounted to the rim 20, the inlet and outlet ports 22, 28 are in respective registration with each other and can have any suitable angular displacement therebetween (e.g., 70° between inlets and outlets, 90° between inlets and outlets, etc.) to clear a vehicle body.

The cover 16 is configured to completely cover the inboard well of the free-wheeling hub wheel 12 and connect with the rim 20 such that a sealed cavity is formed by the rim 20, disk plate assembly 24, and cover 16. In this example, the cover 16 defines a flexible lip 30 around its outer edge. Much like a lid for a bowl, the flexible lip 30 slightly bends over a flange of the rim 20 as it is pressed onto the free-wheeling hub wheel 12. Because the flexible lip 30 is slightly smaller in diameter than the outer diameter of the flange, tension in the flexible lip 30 causes it to grip the flange tightly. Once the cover 16 is fully seated, the flexible lip 30 snaps back into place, potentially producing a snap-like sound. This indicates the cover 16 is secure and properly engaged—creating a seal between the free-wheeling hub wheel 12 and cover 16. Alternatively, the cover 16 may be mechanically fastened (e.g., bolted, clamped, etc.) or otherwise attached to the flange or other parts of the free-wheeling hub wheel 12 provided that such attachment results in a seal between the free-wheeling hub wheel 12 and cover 16. The cover 16 further defines an aperture 32 at a center thereof configured to permit a vehicle shaft associated with a vehicle wheel hub to pass therethrough.

During use of the free-wheeling hub wheel system 10, the cavity mentioned above contains a vehicle brake assembly 34, which in this example includes a brake rotor 36 and a caliper assembly 38 with brake pads. Mounting bores of the brake rotor 36 are in registration with mounting bores (inboard vehicle) of the floating hub assembly 26, and the vehicle wheel hub is bolted thereto such that the vehicle shaft, vehicle wheel hub, floating hub assembly 26, and brake rotor 36 may rotate relative to the tire 14, conduit 18, and rim 20, which remain stationary.

A dynamometer mount 40 is attached (e.g., bolted, splined, etc.) to a side of the floating hub assembly 26 opposite that of the vehicle wheel hub (outboard vehicle). It may be attached, for example, with a shaft of a dynamometer (e.g., a powertrain dynamometer) or a drum such that the drum may be carried by rollers of a chassis dynamometer. Other dynamometer interface arrangements are also contemplated. The dynamometer mount 40 thus rotates with the floating hub assembly 26 and relative to the tire 14, conduit 18, and rim 20. Braking and motoring torques of a vehicle can thus be transferred to the dynamometer via the free-wheeling hub wheel system 10.

So arranged, particulate emissions generated during testing of the vehicle brake assembly 34 will be contained with the sealed cavity formed by the cover, rim 20, and disk plate assembly 24. As discussed further below, air directed through the sealed cavity via the conduit 18 will transport the particulate emissions for analysis.

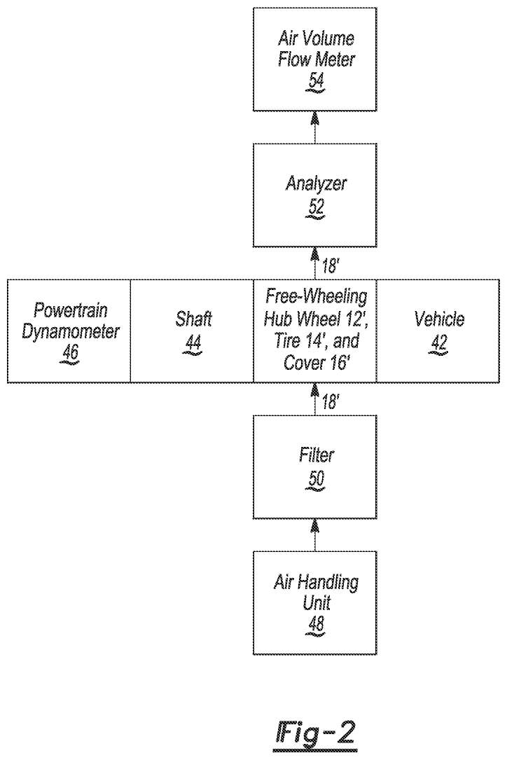

Referring to FIG. 2, a free-wheeling hub wheel 12′, tire 14′, and cover 16′ are arranged to facilitate testing of a brake assembly of vehicle 42. The free-wheeling hub wheel 12′, tire 14′, and cover 16′ are similar to that described in FIGS. 1A-1C, except the conduit 18′ are aligned (aligned along a same axis) relative to the free-wheeling hub wheel 12′ and tire 14′. In this example, the free-wheeling hub wheel 12′ is attached via a shaft 44 to a powertrain dynamometer 46.

Air from an air handling unit 48 is directed through a filter 50 and into the sealed cavity defined by the free-wheeling hub wheel 12′ and cover 16′ and containing the brake assembly under test via the conduit 18′ (input), which passes through the tire 14′ and then the rim 20′. The air handling unit 48 may alter a velocity of the air to maintain a desired temperature (e.g., a temperature measured from real-world driving) of the brake assembly. The air handling unit 48 may also alter a temperature or humidity of the air to reflect real-world driving conditions. This air now laden with particulate matter from the test exits the sealed cavity via the conduit 18′ (output), which passes through the rim 20′ and then the tire 14′, and is delivered to an analyzer 52 and then an air flow meter 54.

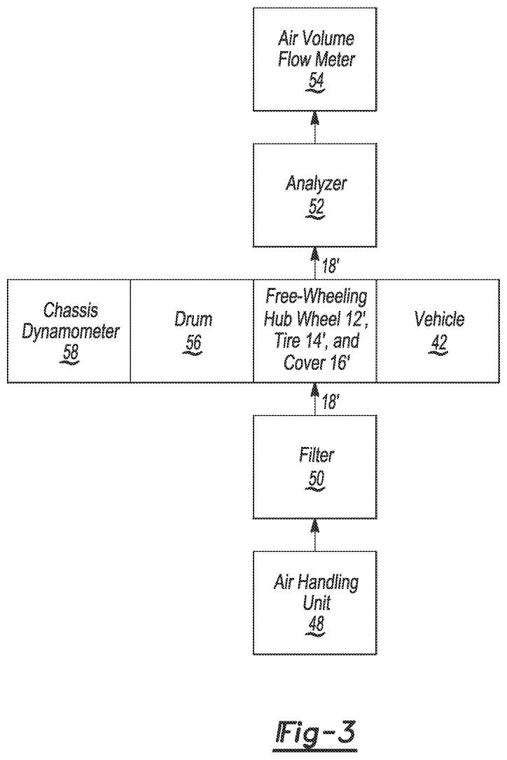

Referring to FIG. 3, the free-wheeling hub wheel 12′ is attached via a drum 56 to a chassis dynamometer 58. The drum 56 acts as vehicle tire to form a torque transfer path to the roll(s) of the chassis dynamometer 58.

The arrangements of FIGS. 2 and 3 may be extended to all four corners of a vehicle so that all brake assemblies can be emissions tested at the same time. Conduits would branch from the filter before travelling to each of the free-wheeling hub wheel systems. Conduits would also rejoin from the free-wheeling hub wheel systems before travelling to the analyzer. A single air handling unit, filter, analyzer, and air flow meter could thus be used to assess all the brake assemblies of a vehicle.

Because the rims and tires of the free-wheeling hub wheel systems contemplated herein do not rotate, contamination from tire dust and other particles experienced by rotating test systems will be minimized. This lack of rotation will also permit a better seal between the rims and covers contemplated herein, further improving accuracy.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A driving brake emissions measurement system comprising:
a free-wheeling hub wheel and tire assembly, including a stationary rim and tire each defining inlet and outlet ports, operatively arranged with a dynamometer and mounted to a wheel hub of a vehicle such that braking and motoring torques of the vehicle are transferred to the dynamometer via the free-wheeling hub wheel and tire assembly and the free-wheeling hub wheel and tire assembly surrounds a brake of the vehicle;
a cover disposed over the brake and mounted to the free-wheeling hub wheel and tire assembly such that the rim and cover define a sealed container completely encapsulating the brake to capture emissions from the brake; and
conduit passing through the tire via the inlet and outlet ports and configured to direct fluid through the sealed container to carry the emissions out of the sealed container and to an analyzer.

2. The driving brake emissions measurement system of claim 1, wherein the free-wheeling hub wheel and tire assembly further includes a floating hub configured to rotate relative to the rim and tire and wherein the free-wheeling hub wheel and tire assembly is mounted to the wheel hub of the vehicle via the floating hub.

3. The driving brake emissions measurement system of claim 1, wherein the inlet and outlet ports are axially aligned.

4. The driving brake emissions measurement system of claim 1, wherein the dynamometer is a powertrain dynamometer, and the free-wheeling hub wheel and tire assembly is connected to the wheel dynamometer via a shaft.

5. The driving brake emissions measurement system of claim 1, wherein the dynamometer is a chassis dynamometer, and the free-wheeling hub wheel and tire assembly is connected to the chassis dynamometer via a drum.

6. The driving brake emissions measurement system of claim 1, wherein the fluid is filtered air.

7. A free-wheeling hub wheel system comprising:
a free-wheeling hub wheel configured to be mounted to a wheel hub of a vehicle such that the free-wheeling hub wheel surrounds a brake of the vehicle, and including a rim defining inlet and outlet ports; and
a cover configured to be disposed over the brake and mounted around a perimeter of the rim such that the rim and cover define a sealed container completely encapsulating the brake to capture emissions from the brake.

8. The free-wheeling hub wheel system of claim 7 further comprising a tire, mounted on the rim, further defining the inlet and outlet ports.

9. The free-wheeling hub wheel system of claim 8 further comprising conduit passing through the tire via the inlet and outlet ports and configured to direct fluid through the sealed container.

10. The free-wheeling hub wheel system of claim 7, wherein the inlet and outlet ports are axially aligned.

11. The free-wheeling hub wheel system of claim 7, wherein the free-wheeling hub wheel further includes a floating hub configured to rotate relative to the rim.

12. A brake emissions testing method comprising:
directing fluid in to and out of a sealed cavity defined by a stationary rim and cover of a free-wheeling hub wheel and tire assembly via conduit passing through a stationary tire of the free-wheeling hub wheel and tire assembly that is mounted on the rim to collect emissions from a brake contained within the sealed cavity.

13. The brake emissions testing method of claim 12 further comprising analyzing the emissions.

14. The brake emissions testing method of claim 12 further comprising altering a velocity of the fluid via an air handling unit to maintain a temperature of the brake.

15. The brake emissions testing method of claim 12 further comprising altering a temperature or humidity of the fluid via an air handling unit.
